(19) United States
(12) Patent Application Publication
(10) Pub. No.: US 2024/0235262 A9
(43) Pub. Date: Jul. 11, 2024

(54) WIRELESS CHARGING SYSTEM WITH RECEIVER CONTROL

(71) Applicant: Google LLC, Mountain View, CA (US)

(72) Inventors: Li Wang, Mountain View, CA (US); Liang Jia, Palo Alto, CA (US)

(21) Appl. No.: 18/546,120

(22) PCT Filed: Feb. 23, 2021
(86) PCT No.: PCT/US2021/019183

§ 371 Date: Aug. 11, 2023

(51) Int. Cl. H02J 50/10; H02J 50/40; H02M 7/219

(52) U.S. Cl. CPC H02J 50/10; H02J 50/402; H02M 7/219

(57) ABSTRACT

An example device (204) includes a wireless charging receive coil (222) configured to transduce, into an alternating current—AC—power signal, a magnetic field generated by a wireless charging transmit coil (218) of an external device (202); an active rectifier (224) configured to convert the AC signal into a direct current—DC—power signal; and circuitry (226) configured to: obtain a target level of the DC power signal; and control the active rectifier (224) to output the DC power signal with the target level.

### BACKGROUND

Computing devices, such as smartphones, laptops, wearable devices, and tablets, may include wireless charging capabilities. Computing devices may operate as wireless charging source devices that wirelessly provide power or wireless charging sink devices that wirelessly receive power. For instance, a wireless charging sink device may include a receiver coil and other components capable of transducing a magnetic field into an electrical power signal that may be used to charge a battery of the computing device or otherwise operate components of the computing device. Similarly, a wireless charging source device may include a power supply that output a signal to a transmitter coil that causes the transmitter coil to generate a magnetic field. A controller of the wireless charging source device may adjust operation of the power supply to control an amount of power provided and/or properties of the electrical power signal at the wireless charging receive device.

### SUMMARY

This disclosure generally relates to a wireless charging sink device that is configured to internally regulate a power signal transduced from a magnetic field generated by a wireless charging source device. The wireless charging sink device may include a coil that transduces the magnetic field into an alternating current (AC) power signal, a rectifier configured to convert the AC power signal into a direct current (DC) power signal, a DC/DC power converter configured to regulate one or more aspects (e.g., voltage or current) of the DC power signal to generate a regulated DC power signal, and one or more components (e.g., a battery charger) configured to operate using the regulated DC power signal. For various reasons (e.g., the DC/DC power converter may only be able to regulate within a certain range), primary regulation of the DC power signal used by the components of the wireless charging sink device may be accomplished via a control loop that includes the wireless charging sink device outputting sensed levels (e.g., voltage and/or current of the DC power signal) to the wireless charging source device, which adjusts output of the magnetic field in an effort to cause the sensed levels to reach target levels. Such an arrangement may not be desirable. As one example, including the DC/DC power converter in the wireless charging sink device may take up space and increase a cost of the wireless charging sink device. As another example, the control loop may have a large latency, which may increase response time.

In accordance with one or more aspects of this disclosure, a wireless charging sink device may include an active rectifier that not only converts an AC power signal output by a wireless charging receive coil to a DC power signal, but also regulates level(s) of the DC power signal to reach target level(s). For instance, circuitry of the wireless charging sink device may sense a level (e.g., voltage or current) of the AC power signal output by the wireless charging receive coil and/or a level (e.g., voltage or current) of the DC power signal output by the active rectifier, compute an error between the sensed level and a target level, and adjust a control signal provided to switches of the active rectifier such that the active rectifier output a DC power signal with the target level. In this way, the wireless charging sink device may omit inclusion of a separate DC/DC converter and/or may have an improved (e.g., reduced) response time.

As one example, a device includes a wireless charging receive coil configured to transduce, into an alternating current (AC) power signal, a magnetic field generated by a wireless charging transmit coil of an external device; an active rectifier configured to convert the AC signal into a direct current (DC) power signal; and circuitry configured to: obtain a target level of the DC power signal; and control the active rectifier to output the DC power signal with the target level.

As another example, a plurality of wireless charging sink devices, each respective wireless charging sink device of the wireless charging sink devices comprising: a respective wireless charging receive coil configured to transduce, into a respective alternating current (AC) power signal, a respective magnetic field generated by a respective wireless charging transmit coil of a wireless charging source device; a respective active rectifier configured to convert the respective AC signal into a respective direct current (DC) power signal; and respective circuitry configured to: obtain a respective target level of the respective DC power signal; and control the respective active rectifier to output the respective DC power signal with the respective target level.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating a system that includes a wireless charging source device and a wireless charging sink device that includes an active rectifier configured to perform power regulation, in accordance with one or more aspects of this disclosure.

FIG. 2 is a schematic diagram illustrating a system that includes a wireless charging source device and a wireless charging sink device that includes an active rectifier configured to perform power regulation, in accordance with one or more aspects of this disclosure.

FIG. 3 is a schematic diagram illustrating a system that includes a wireless charging source device and a wireless charging sink device that includes an active rectifier configured to perform power regulation, in accordance with one or more aspects of this disclosure.

FIG. 4 is a schematic diagram illustrating a system that includes a wireless charging source device and a plurality of wireless charging sink devices that each include an active rectifier configured to perform power regulation, in accordance with one or more aspects of this disclosure.

FIG. 5 is a flowchart illustrating a technique for receiver controlled wireless charging, in accordance with one or more techniques of this disclosure.

### DETAILED DESCRIPTION

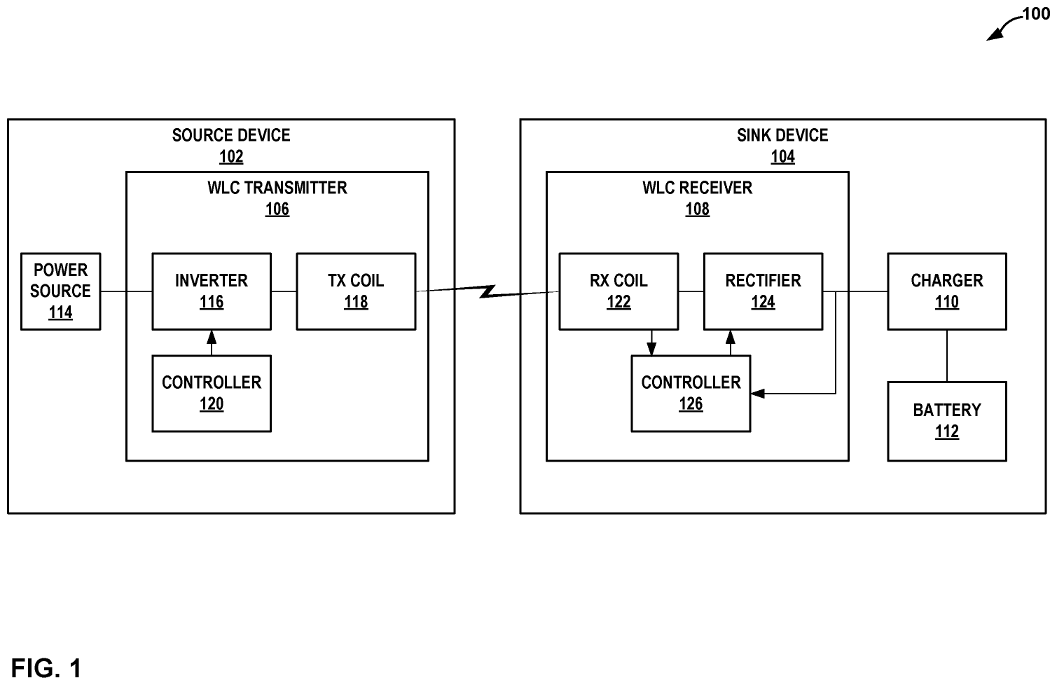

FIG. 1 is a block diagram illustrating a system that includes a wireless charging source device and a wireless charging sink device that includes an active rectifier configured to perform power regulation, in accordance with one or more aspects of this disclosure. As shown in FIG. 1, system 100 may include wireless charging source device 102 (“source device 102”) and wireless charging sink device 104 (“sink device 104”).

Source device 102 may be any type of device that wirelessly provides power to another device. Examples of source device 102 include, but are not limited to, a charging pad, an alarm clock, a power bank, a mobile phone, a camera device, a tablet computer, a smart display, a laptop computer, a desktop computer, a gaming system, a media player, an e-book reader, a television platform, a vehicle infotainment system or head unit, a vehicle surface with integrated charging, or a wearable computing device (e.g., a computerized watch, a head mounted device such as a VR/AR headset, computerized eyewear, a computerized glove). As shown in FIG. 1, source device 102 may include wireless charging (WLC) transmitter 106 and power source 114.

Power source 114 may be any component capable of providing electrical power to other components of source device 102. Examples of power source 114 include, but are not limited to, batteries, solar panels, wall adapters, wireless charging receive coils, etc. As shown in FIG. 1, power source 114 may provide electrical power (e.g., direct current (DC) electrical power) to WLC transmitter 106.

WLC transmitter 106 may be configured to wirelessly provide power to another device. In some examples, WLC transmitter 106 may be compliant with (e.g., operate in accordance with) a wireless charging standard such as the Qi specification published by the Wireless Power Consortium (e.g., available at wirelesspowerconsortium.com/knowledge-base/specifications/download-the-qi-specifications.html). As shown in FIG. 1, WLC transmitter 106 may include inverter 116, transmitter (Tx) coil 118, and controller 120.

Inverter 116 may be configured to convert a direct current (DC) signal into an alternating current (AC) signal. For instance, inverter 116 may convert a DC power signal received from power source 114 into an AC power signal, and provide the AC power signal to Tx coil 118. As discussed in further detail below, in some examples, inverter 116 may be an active full bridge inverter that includes a plurality of switches. Operation of the plurality of switches may be controlled by a controller, such as controller 120.

Controller 120 may be configured to control operation of one or more components of WLC transmitter 106. For instance, controller 120 may include circuitry configured to control operation of inverter 116. As one example, the circuitry of controller 120 may adjust one or more of a voltage level of the DC signal provided to inverter 116, a switching frequency of switches of inverter 116, and/or a duty cycle of the switches of inverter 116. Examples of controller 120 include, but are not limited to, one or more digital signal processors (DSPs), general purpose microprocessors, application specific integrated circuits (ASICs), field programmable logic arrays (FPGAs), systems on a chip (SoC), or other equivalent integrated or discrete logic circuitry, or analog circuitry.

Tx coil 118 may be configured to generate a magnetic field proportional to a power signal flowing through Tx coil 118. For instance, Tx coil 118 may generate a magnetic field having properties proportional to the AC power signal output to Tx coil 118 from inverter 116.

Sink device 104 may be any type of device that operates at least in part using power wirelessly received from another device. Examples of sink device 104 include, but are not limited to, a power bank, a mobile phone, a camera device, a tablet computer, a smart display, a laptop computer, a desktop computer, a gaming system, a media player, an e-book reader, a television platform, or a wearable computing device. As shown in FIG. 1, sink device 104 may include wireless charging (WLC) receiver 108, charger 110, and battery 112.

WLC receiver 108 may be configured to wirelessly receive power from another device. In some examples, WLC receiver 108 may be compliant with (e.g., operate in accordance with) a wireless charging standard such as the Qi specification published by the Wireless Power Consortium (e.g., available at wirelesspowerconsortium.com/knowledge-base/specifications/download-the-qi-specifications.html). As shown in FIG. 1, WLC receiver 108 may include receiver (Rx) coil 122, rectifier 124, and controller 126.

Rx coil 122 may be configured to transduce a magnetic field into a power signal. For instance, Rx coil 122 may transduce the magnetic field generated by Tx coil 118 into an AC power signal having properties proportional to the magnetic field (e.g., and thus proportional to AC power signal output to Tx coil 118 from inverter 116). Rx coil 122 may output the transduced AC power signal to one or more components of WLC receiver 108, such as rectifier 124.

Rectifier 124 may be configured to convert an AC signal into a DC signal. For instance, rectifier 124 may convert an AC power signal received from Rx coil 122 into a DC power signal, and provide the DC power signal to another component of sink device 104, such as charger 110. As discussed in further detail below, in some examples, rectifier 124 may be an active full bridge rectifier that includes a plurality of switches. In this sense, rectifier 124 may be considered to be an active rectifier (e.g., as opposed to a bridge formed entirely of passive diodes). Operation of the plurality of switches may be controlled by a controller, such as controller 126.

Controller 126 may be configured to control operation of one or more components of WLC receiver 108. For instance, controller 126 may include circuitry configured to control operation of rectifier 124. As one example, the circuitry of controller 126 may adjust one or more of a switching frequency of switches of rectifier 124, and/or a duty cycle of the switches of rectifier 124. Examples of controller 126 include, but are not limited to, one or more digital signal processors (DSPs), general purpose microprocessors, application specific integrated circuits (ASICs), field programmable logic arrays (FPGAs), systems on a chip (SoC), or other equivalent integrated or discrete logic circuitry, or analog circuitry.

Components of sink device 104 may utilize the DC power signal output by WLC receiver 108 to perform various operations. For instance, charger 110 may utilize the DC power signal output by WLC receiver 108 to charge battery 112.

In accordance with one or more aspects of this disclosure, rectifier 124 may perform one or more operations such that the DC power signal output by rectifier 124 is a regulated DC power signal. For instance, controller 126 may implement a closed loop control in which controller 126 obtains a target level of the DC power signal (e.g., a target voltage level or a target current level), and controls rectifier 124 to output the DC power signal with the target level. As one example, controller 126 may obtain a target voltage level of the DC power signal, obtain an actual voltage level of the DC power signal (Vout), and control switches of rectifier 124 such that the actual voltage level of the DC power signal becomes the target voltage level. As another example, controller 126 may obtain a target current level, obtain an actual current level (I), and control switches of rectifier 124 such that the actual current level becomes the target current level.

Controlling operation of rectifier 124 to output the DC power signal with the target level may present one of more advantages. As one example, using rectifier 124 to regulate the DC power signal may enable sink device 104 to omit inclusion of a separate DC/DC converter (e.g., a separate low dropout (LDO) regulator between rectifier 124 and charger 110. In this way, charger 110 may receive the DC power signal directly from rectifier 124. As another example, using rectifier 124 to regulate the DC power signal may enable sink device 104 to perform the regulation without necessarily having to implement a feedback loop in which source device 102 performs the regulation. By performing the regulation without involvement of source device 102, this disclosure may have an improved response time.

In some examples, charger 110 may be omitted. For instance, rectifier 124 may operate as a combined rectifier-charger that directly outputs a DC power signal to charge battery 112. In this way, a quantity of components may be further reduced.

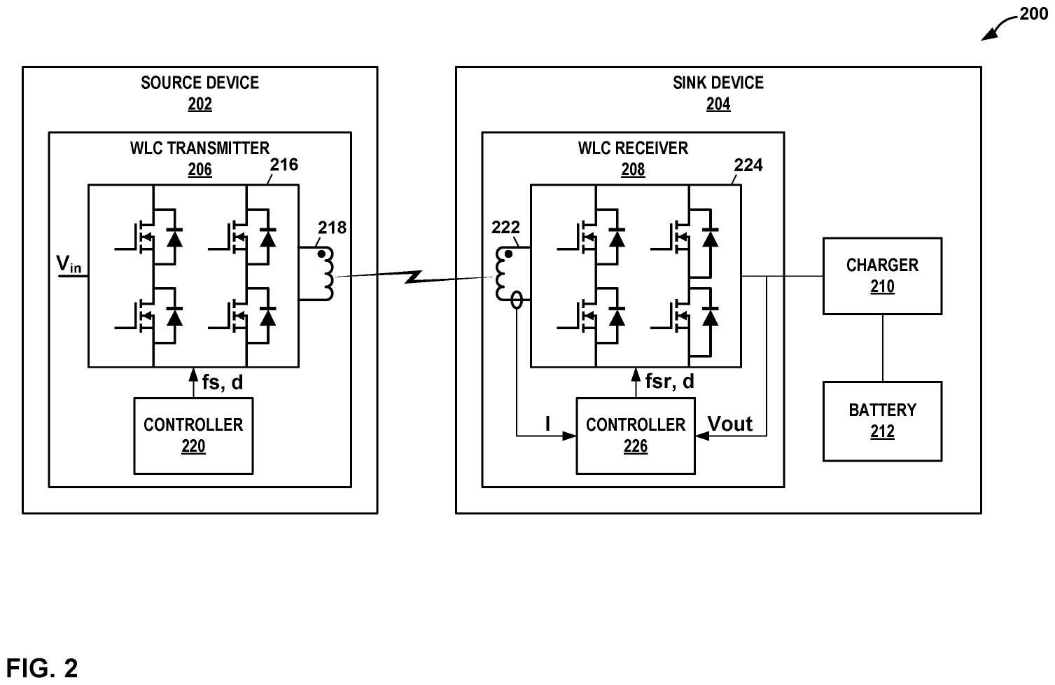

FIG. 2 is a schematic diagram illustrating a system that includes a wireless charging source device and a wireless charging sink device that includes an active rectifier configured to perform power regulation, in accordance with one or more aspects of this disclosure. Source device 202 and sink device 204 of system 200 of FIG. 2 may be configured to be examples of, and perform similar functions to, source device 102 and sink device 104 of system 100 of FIG. 1. Elements with common suffix numbers may be considered to perform similar functions. As one example, Rx coil 222, rectifier 224, and controller 226 of WLC receiver 208 of FIG. 2 may perform similar functions as Rx coil 122, rectifier 124, and controller 126 of WLC receiver 108 of FIG. 1. As another example, charger 210 and battery 212 may perform similar functions as charger 110 and battery 112 of FIG. 1. As another example, Tx coil 218, inverter 216, and controller 220 of WLC transmitter 206 of FIG. 2 may perform similar functions as Tx coil 118, inverter 116, and controller 120 of WLC transmitter 106 of FIG. 1.

As shown in FIG. 2, rectifier 224 may include a plurality of switches driven by a control signal. In some examples, all of the switches (e.g., MOSFETs of any other switch type) of rectifier 224 may be controlled as active switches. For instance, the control signal may be provided to the switches (e.g., to gates) that causes the switches to open, close, or operate in an intermediate semiconducting state. To control rectifier 224, controller 226 may adjust a switching frequency (fsr) and/or a duty cycle (d) of a control signal that drives the switches of rectifier 224. In this way, controller 226 may control the phase shift of the MOSFET full-bridge. In some examples, controller 226 may utilize a resonant tank current zero crossing of voltage zero crossing as a starting point for phase shifting.

In operation, controller 226 may control operation of rectifier 224 to output a DC power signal (e.g., to charger 210) with a target level. For instance, controller 226 may obtain an actual level (e.g., an actual current level I or an actual voltage level I), and control, based on the obtained actual level of the DC power signal, operation of the active rectifier to output the DC power signal with the target level. As one specific example, where the actual voltage level of the DC power signal (Vout) is greater than a target voltage level, controller 226 may adjust the control signal supplied to the switches of rectifier 224 to reduce the actual level of the DC power signal.

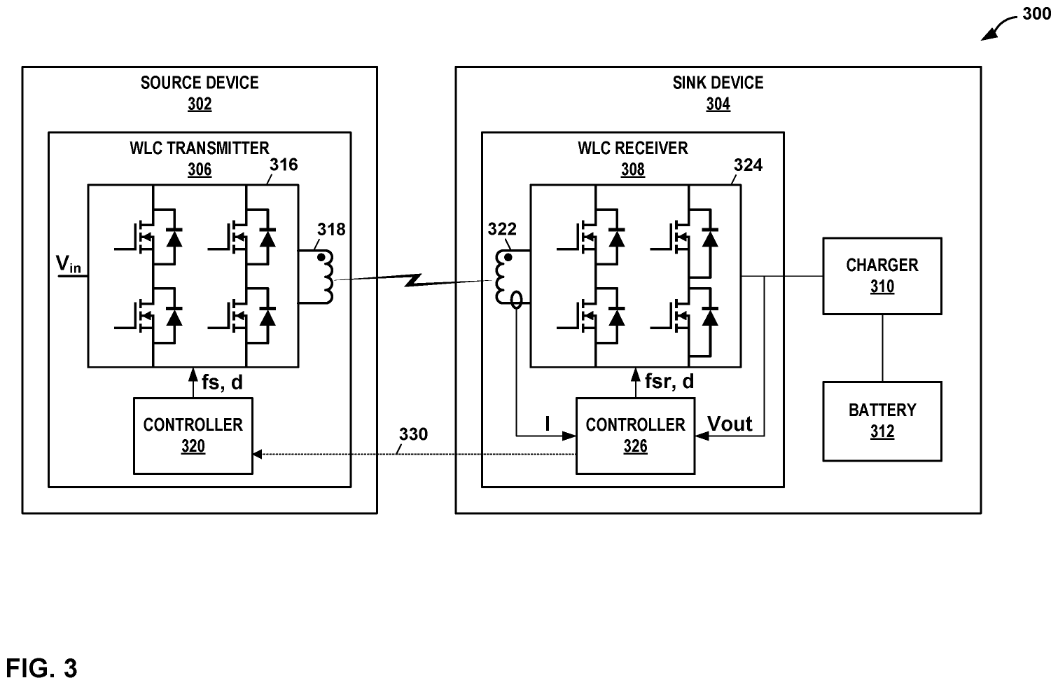

FIG. 3 is a schematic diagram illustrating a system that includes a wireless charging source device and a wireless charging sink device that includes an active rectifier configured to perform power regulation, in accordance with one or more aspects of this disclosure. Source device 302 and sink device 304 of system 300 of FIG. 3 may be configured to be examples of, and perform similar functions to, source device 102 and sink device 104 of system 100 of FIG. 1. Elements with common suffix numbers may be considered to perform similar functions. As one example, Rx coil 322, rectifier 324, and controller 326 of WLC receiver 308 of FIG. 3 may perform similar functions as Rx coil 122, rectifier 124, and controller 126 of WLC receiver 108 of FIG. 1. As another example, charger 310 and battery 312 may perform similar functions as charger 110 and battery 112 of FIG. 1. As another example, Tx coil 318, inverter 316, and controller 320 of WLC transmitter 306 of FIG. 3 may perform similar functions as Tx coil 118, inverter 116, and controller 120 of WLC transmitter 106 of FIG. 1.

In some examples, it may be desirable for sink device 304 to maintain a feedback loop with source device 302 even though at least some power regulation is performed by rectifier 324. For instance, it may be desirable to minimize the amount of regulation performed by rectifier 324.

In accordance with one or more aspects of this disclosure, system 300 may implement two control loops. In a first control loop, controller 326 may control operation of rectifier 324 such that rectifier 324 outputs the DC power signal (e.g., to charger 310) with the desired level (e.g., voltage level or current level). In a second control loop, controller 326 may provide feedback to source device 302 that causes source device 302 to adjust characteristics of the magnetic field. For instance, controller 326 may transmit, to source device 302, a representation of a difference between an actual level of a power signal and a target level of the power signal (e.g., a difference between Vout and a target voltage level or a difference between I and a target current level). The difference may be referred to as an error signal.

The communication between sink device 304 and source device 302 may be accomplished using any suitable communication protocol. As one specific example, sink device 304 may transmit the representation of the difference using amplitude shift keying (ASK) at 2 Hz (e.g., in accordance with the Qi standard).

Controller 320 of source device 302 may adjust operation of one or more components of source device 302 based on the representation of the difference. For instance, where the error signal indicates that an actual voltage level of the power signal is greater than a target voltage level, controller 320 may adjust operation of inverter 316 to reduce a voltage level of the AC signal provided to Tx coil 318. In this way, controller 320 may reduce the amount of regulation needed to be performed at sink device 304.

In operation, controller 326 may control operation of rectifier 324 to output a DC power signal (e.g., to charger 310) with a target level. For instance, controller 326 may obtain an actual level (e.g., an actual current level I or an actual voltage level I), and control, based on the obtained actual level of the DC power signal, operation of the active rectifier to output the DC power signal with the target level. As one specific example, where the actual voltage level of the DC power signal (Vout) is less than a target voltage level, controller 326 may adjust the control signal supplied to the switches of rectifier 324 to increase the actual level of the DC power signal. Additionally or alternatively, controller 326 may output a signal to controller 320 requesting that source device 302 adjust generation of the magnetic field so as to increase a voltage level of the AC signal transduced by Rx coil 322.

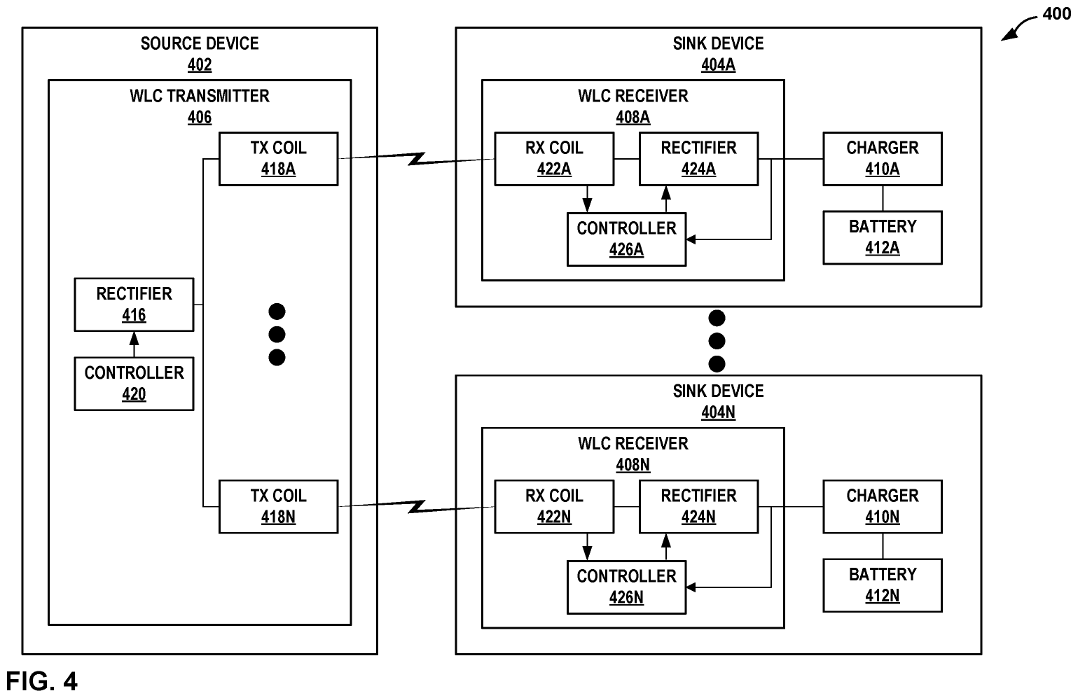

FIG. 4 is a schematic diagram illustrating a system that includes a wireless charging source device and a plurality of wireless charging sink devices that each include an active rectifier configured to perform power regulation, in accordance with one or more aspects of this disclosure. Source device 402 of system 400 of FIG. 4 may be configured to be examples of, and perform similar functions to, source device 102 of system 100 of FIG. 1. Each of sink devices 404A-404N (collectively, “sink devices 404”) of system 400 of FIG. 4 may be configured to be examples of, and perform similar functions to, sink device 104 of system 100 of FIG. 1. Elements with common suffix numbers may be considered to perform similar functions. As one example, each of Rx coils 422A-422N (collectively, “Rx coils 422”), rectifiers 424A-424N (collectively, “rectifiers 424”), and controllers 426A-426N (collectively, “controllers 426”) of WLC receivers 408A-408N (collectively, “WLC receivers 408”) of FIG. 4 may perform similar functions as Rx coil 122, rectifier 124, and controller 126 of WLC receiver 108 of FIG. 1. As another example, each of chargers 410A-410N (collectively, “chargers 410”), batteries 412A-412N (collectively, “batteries 412”) of sink devices 404 may perform similar functions to charger 110 and battery 112 of sink device 104 of FIG. 1. As another example, rectifier 416, each of Tx coils 418A-418N (collectively, “Tx coils 418”), and controller 420 of WLC transmitter 406 of FIG. 4 may perform functions similar to rectifier 116, Tx coil 118, and controller 120 of WLC transmitter 106 of FIG. 1

As can be seen in FIG. 4, the techniques of this disclosure enable a single source device to concurrently wirelessly provide power to a plurality of sink devices (e.g., source device 402 may provide power to sink devices 404 in parallel). Instead of having to include separate controllers/rectifiers for each sink device at source device 402, sink devices 404 may perform internal power regulation in accordance with this disclosure. For instance, each of controllers 426 may control a corresponding rectifier of rectifiers 424 to output a power signal with a different target level. Such an arrangement enables source device 402 to include a single rectifier 416 supplying a common AC power signal to all of Tx coils 418A-418N. In this way, the techniques of this disclosure may reduce a cost of wireless charging source devices.

As shown above, system 400 may include a plurality of wireless charging sink devices, each respective wireless charging sink device of the wireless charging sink devices including: a respective wireless charging receive coil configured to transduce, into a respective AC power signal, a respective magnetic field generated by a respective wireless charging transmit coil of a wireless charging source device, a respective active rectifier configured to convert the respective AC signal into a respective DC power signal, and respective circuitry configured to: obtain a respective target level of the respective DC power signal; and control the respective active rectifier to output the respective DC power signal with the respective target level.

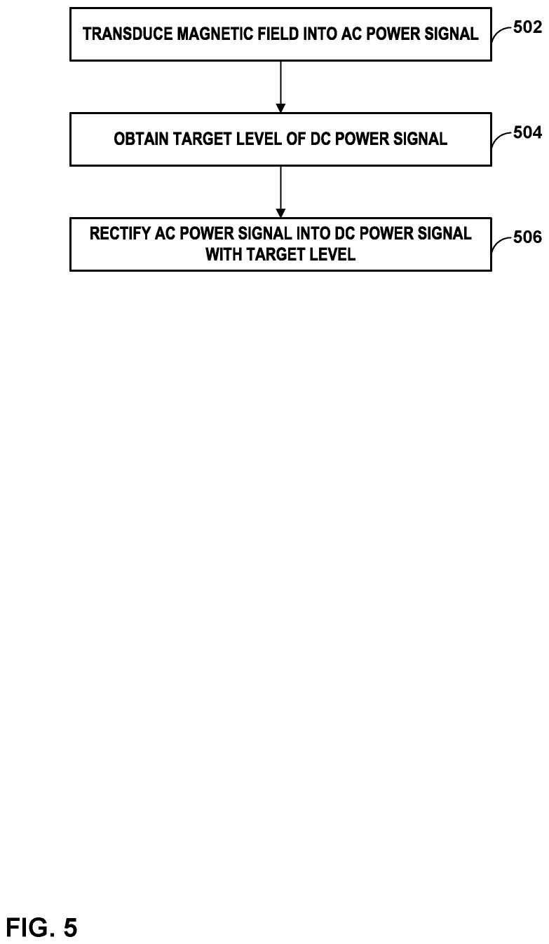

FIG. 5 is a flowchart illustrating a technique for receiver controlled wireless charging, in accordance with one or more techniques of this disclosure. While described in the context of sink device 104 of FIG. 1, other devices may perform the method of FIG. 5 (e.g., sink device 204 of FIG. 2, sink device 304 of FIG. 3, any of sink devices 404 of FIG. 4).

Sink device 104 may transduce a magnetic field into an AC power signal (502). For instance, Rx coil 122 of WLC receiver 108 of sink device 104 may transduce a magnetic field generated by source device 102 into an AC power signal that Rx coil 122 provides to rectifier 124.

Sink device 104 may obtain a target level of a DC power signal (504). For instance, controller 126 may obtain a target voltage or a target current level from memory or any other source.

Sink device 104 may rectify the AC power signal into a DC power signal having the target level (506). For instance, controller 126 may adjust operation of one or more switches of rectifier 124 such that rectifier 124 rectifies the AC power signal into a DC power signal having the target voltage or current level. As discussed above, in some examples, controller 126 may adjust operation of the one or more switches by performing phase shifting of control signals used to operate the switches of rectifier 124 (e.g., adjusting one or both of a switching frequency or a duty cycle of the control signals).

The following numbered examples may illustrate one or more aspects of this disclosure:

Example 1. A computing device comprising: a wireless charging receive coil configured to transduce, into an alternating current (AC) power signal, a magnetic field generated by a wireless charging transmit coil of an external device; an active rectifier configured to convert the AC signal into a direct current (DC) power signal; and circuitry configured to: obtain a target level of the DC power signal; and control the active rectifier to output the DC power signal with the target level.

Example 2. The computing device of example 1, wherein the circuitry is further configured to: obtain an actual level of the DC power signal, wherein, to control the active rectifier, the circuitry is configured to control, based on the obtained actual level of the DC power signal, operation of the active rectifier to output the DC power signal with the target level.

Example 3. The computing device of example 1, wherein the active rectifier comprises a plurality of switches driven by a control signal, and wherein, to control operation of the active rectifier, the circuitry is configured to one or both of: adjust a frequency of the control signal; and adjust a duty cycle of the control signal.

Example 4. The computing device of example 2, wherein the circuitry is further configured to: transmit, to the external device, a representation of a difference between the actual level of the DC power signal and the target level.

Example 5. The computing device of example 1, wherein the target level of the DC power signal is a target voltage level.

Example 6. The computing device of example 1, further comprising: a battery; and a charger configured to charge the battery using the DC power signal, wherein the charger receives the DC power signal directly from the active rectifier.

Example 7. The computing device of example 6, wherein the computing device does not include a low-dropout regulator between the active rectifier and the charger.

Example 8. A system comprising: a plurality of wireless charging sink devices, each respective wireless charging sink device of the wireless charging sink devices comprising: a respective wireless charging receive coil configured to transduce, into a respective alternating current (AC) power signal, a respective magnetic field generated by a respective wireless charging transmit coil of a wireless charging source device; a respective active rectifier configured to convert the respective AC signal into a respective direct current (DC) power signal; and respective circuitry configured to: obtain a respective target level of the respective DC power signal; and control the respective active rectifier to output the respective DC power signal with the respective target level.

Example 9. The system of example 8, further comprising the wireless charging source device, wherein the wireless charging source device includes: a plurality of wireless charging transmit coils; and a rectifier configured to output an AC power signal to the plurality of wireless charging transmit coils.

Example 10. The system of example 8, wherein a respective target level of a first wireless charging sink device of the plurality of wireless charging sink devices is different than a respective target level of a second wireless charging sink device of the plurality of wireless charging sink devices.

Example 11. A method comprising: transducing, by a wireless charging receive coil of a wireless charging sink device, a magnetic field into an alternating current (AC) power signal; rectifying, by an active rectifier of the wireless charging sink device, the AC power signal into a DC power signal; obtaining, by circuitry of the wireless charging sink device, a target level of the DC power signal; and controlling, by the circuitry, the active rectifier to output the DC power signal with the target level.

Example 12. The method of example 11, further comprising: obtaining, by the circuitry, an actual level of the DC power signal, wherein controlling the active rectifier comprises controlling, based on the obtained actual level of the DC power signal, the active rectifier to output the DC power signal with the target level.

Example 13. The method of example 11, wherein the active rectifier comprises a plurality of switches driven by a control signal, and wherein controlling operation of the active rectifier comprises one or both of: adjusting a frequency of the control signal; and adjusting a duty cycle of the control signal.

Example 13. The method of example 12, further comprising: transmitting, to a wireless charging source device that generated the magnetic field, a representation of a difference between the actual level of the DC power signal and the target level.

Example 14. A wireless charging sink device comprising: means for transducing a magnetic field into an alternating current (AC) power signal; means for rectifying the AC power signal into a DC power signal; means for obtaining a target level of the DC power signal; and means for controlling the means for rectifying to output the DC power signal with the target level.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various aspects have been described in this disclosure. These and other aspects are within the scope of the following claims.

1. A computing device comprising:
a wireless charging receive coil configured to transduce, into an alternating current (AC) power signal, a magnetic field generated by a wireless charging transmit coil of an external device;
an active rectifier configured to convert the AC signal into a direct current (DC) power signal; and
circuitry configured to:
obtain a target level of the DC power signal; and
control the active rectifier to output the DC power signal with the target level.

2. The computing device of claim 1, wherein the circuitry is further configured to:
obtain an actual level of the DC power signal,
wherein, to control the active rectifier, the circuitry is configured to control, based on the obtained actual level of the DC power signal, operation of the active rectifier to output the DC power signal with the target level.

3. The computing device of claim 1, wherein the active rectifier comprises a plurality of switches driven by a control signal, and wherein, to control operation of the active rectifier, the circuitry is configured to one or both of:
adjust a frequency of the control signal; and
adjust a duty cycle of the control signal.

4. The computing device of claim 2, wherein the circuitry is further configured to:
transmit, to the external device, a representation of a difference between the actual level of the DC power signal and the target level.

5. The computing device of claim 1, wherein the target level of the DC power signal is a target voltage level.

6. The computing device of claim 1, wherein the target level of the DC power signal is a target current level.

7. The computing device of claim 1, wherein the target level of the DC power signal is a target current level and a target voltage level.

8. The computing device of claim 1, further comprising:
a battery; and
a charger configured to charge the battery using the DC power signal,
wherein the charger receives the DC power signal directly from the active rectifier.

9. The computing device of claim 8, wherein the computing device does not include a low-dropout regulator between the active rectifier and the charger.

10. A system comprising:
a plurality of wireless charging sink devices, each respective wireless charging sink device of the wireless charging sink devices comprising:
a respective wireless charging receive coil configured to transduce, into a respective alternating current (AC) power signal, a respective magnetic field generated by a respective wireless charging transmit coil of a wireless charging source device;
a respective active rectifier configured to convert the respective AC signal into a respective direct current (DC) power signal; and
respective circuitry configured to:
obtain a respective target level of the respective DC power signal; and
control the respective active rectifier to output the respective DC power signal with the respective target level.

11. The system of claim 10, further comprising the wireless charging source device, wherein the wireless charging source device includes:
a plurality of wireless charging transmit coils; and
a rectifier configured to output an AC power signal to the plurality of wireless charging transmit coils.

12. The system of claim 10, wherein a respective target level of a first wireless charging sink device of the plurality of wireless charging sink devices is different than a respective target level of a second wireless charging sink device of the plurality of wireless charging sink devices.

13. A method comprising:
transducing, by a wireless charging receive coil of a wireless charging sink device, a magnetic field into an alternating current (AC) power signal;
rectifying, by an active rectifier of the wireless charging sink device, the AC power signal into a DC power signal;
obtaining, by circuitry of the wireless charging sink device, a target level of the DC power signal; and
controlling, by the circuitry, the active rectifier to output the DC power signal with the target level.

14. The method of claim 13, further comprising:
obtaining, by the circuitry, an actual level of the DC power signal,
wherein controlling the active rectifier comprises controlling, based on the obtained actual level of the DC power signal, the active rectifier to output the DC power signal with the target level.

15. The method of claim 13, wherein the active rectifier comprises a plurality of switches driven by a control signal, and wherein controlling operation of the active rectifier comprises one or both of:
adjusting a frequency of the control signal; and
adjusting a duty cycle of the control signal.

16. The method of claim 14, further comprising:
transmitting, to a wireless charging source device that generated the magnetic field, a representation of a difference between the actual level of the DC power signal and the target level.

17. (canceled)

18. A computing device comprising:
a wireless charging receive coil configured to transduce, into an alternating current (AC) power signal, a magnetic field generated by a wireless charging transmit coil of an external device;
an active rectifier configured to convert the AC signal into a direct current (DC) power signal, the active rectifier comprising a plurality of switches driven by a control signal;
a battery;
a charger configured to charge the battery using the DC power signal; and
circuitry configured to:
obtain an actual level of the DC power signal;
obtain a target level of the DC power signal;
transmit, to the external device, a representation of a difference between the actual level of the DC power signal and the target level; and
control the active rectifier to output the DC power signal with the target level, wherein, to control operation of the active rectifier, the circuitry is configured to one or both of:
adjust a frequency of the control signal; and
adjust a duty cycle of the control signal.
